(19) United States
(12) Patent Application Publication
(10) Pub. No.: US 2026/0018310 A1
(43) Pub. Date: Jan. 15, 2026

(54) THREE-DIMENSIONAL THERMAL-HYDRAULIC ANALYSIS METHOD AND SYSTEM FOR REACTOR CORE

(71) Applicant: Harbin Engineering University, Harbin City (CN)

(72) Inventors: Guangliang CHEN, Harbin City (CN); Hongwei JIANG, Harbin City (CN); Yizhuo XIANG, Harbin City (CN); Hao QIAN, Harbin City (CN)

(73) Assignee: Harbin Engineering University, Harbin City (CN)

(21) Appl. No.: 19/217,311

(22) Filed: May 23, 2025

(30) Foreign Application Priority Data
Jul. 10, 2024 (CN) 202410923330.1

(51) Int. Cl. G21D 3/00

(52) U.S. Cl. CPC G21D 3/005; G21D 3/002

(57) ABSTRACT

Provided is a three-dimensional thermal-hydraulic analysis method and system for a reactor core. The method includes: analyzing a type of a reactor core, dividing an outer-layer mesh and a computational mesh, and establishing a conservative mapping relationship and a set of transport equations; decomposing a coolant viscosity-induced frictional effect, and representing a turbulent mixing-induced exchange of a physical quantity through a source term; establishing a three-dimensional set of governing equations including mass, momentum, and energy conservation equations to describe a flow and heat transfer phenomenon within coolant channels, and forming a fully assembled matrix system based on the set of transport equations; setting a boundary condition and an initial condition for a physical field of the reactor core, and setting an initial field; and iteratively solving the fully assembled matrix system, and obtaining a thermal-hydraulic parameter.

### CROSS REFERENCE TO RELATED APPLICATION

This patent application claims the benefit and priority of Chinese Patent Application No. 202410923330.1, filed with the China National Intellectual Property Administration on Jul. 10, 2024, the disclosure of which is incorporated by reference herein in its entirety as part of the present application.

### BACKGROUND OF THE INVENTION

### Field of the Invention

The present disclosure relates to the technical field of thermal-hydraulic design for reactor cores, and in particular to a three-dimensional thermal-hydraulic analysis method and system for a reactor core.

### Description of the Related Art

The thermal-hydraulic design of reactors aims to determine the heat removal capacity of the reactor core and the flow characteristics of the coolant, ensuring that the heat generated in the reactor core is safely and reliably removed through the coolant. To guarantee reactor safety and economic efficiency, it is necessary to monitor variations in thermal-hydraulic parameters of the reactor and ensure that thermal parameters remain within the design limits specified by thermal design criteria. Currently, thermal-hydraulic analysis methods for reactor cores primarily include the single-channel analysis method, subchannel analysis method, and computational fluid dynamics (CFD) analysis method. In the single-channel analysis method, all coolant channels to be computed are treated as isolated and enclosed, without mass, momentum, or energy exchange with each other. This method is unsuitable for open coolant channels in pressurized water reactors. To better simulate the mixing effects between coolant channels, the subchannel analysis method was developed, accompanied by specialized codes such as coolant-boiling in rod arrays-two fluids (COBRA-TF) and multichannel analyzer for steady states and transients in rod arrays (MATRA). However, the subchannel analysis method assumes that the axial velocity is significantly greater than the transverse velocity, and cannot rigorously solve the transverse momentum equation and instead simplifies the actual three-dimensional flow in the reactor core to a two-dimensional flow for solving. Consequently, it fails to resolve the actual three-dimensional flow field. Additionally, parameters such as coolant velocity and temperature obtained from this method are averaged values within the channels, neglecting the refined distribution of physical fields in the coolant channels. With the rapid advancement of computational resources, the CFD method can now enable three-dimensional refined modeling of reactor cores to solve three-dimensional flow fields, temperature fields, and other parameters. However, due to current computational limitations, performing CFD-based computational analysis of reactor cores in engineering applications remains impractical.

In summary, the single-channel analysis method and the subchannel analysis method exhibit low fidelity but offer advantages such as low requirements for computational resources, fast computation, and simple modeling. In contrast, the CFD method is characterized by high requirements for computational resources, slow computation, and complex modeling, but it offers the advantage of high fidelity. Given the features of these thermal-hydraulic analysis methods at different scales, the present disclosure integrates their strengths while addressing their limitations. Specifically, the present disclosure develops an intermediate-fidelity thermal-hydraulic computational method to enable rapid core computations, achieving medium fidelity and supporting full-core steady-state and transient analysis.

### BRIEF SUMMARY OF THE INVENTION

An objective of the present disclosure is to provide a three-dimensional thermal-hydraulic analysis method and system for a reactor core. The present disclosure supports thermal-hydraulic computational analysis for a type of reactor with an open fuel assembly. It enables three-dimensional flow field computations for fine subchannels, overcoming limitations of the subchannel analysis method such as low resolution and inability to resolve transverse flow distribution or three-dimensional flow fields. Additionally, the present disclosure supports the decomposition of a coolant viscosity-induced frictional effect and explicitly and independently computes turbulent mixing-induced exchanges of physical quantities, reducing computational complexity and uncertainty associated with simulating intricate turbulent motions.

To achieve the above objective, the present disclosure provides the following technical solutions.

A three-dimensional thermal-hydraulic analysis method for a reactor core includes the following steps:
S1: analyzing a type of a reactor core; determining a type of a rod bundle channel to be solved and a solution domain; dividing a fine subchannel control volume, and forming an outer-layer mesh; dividing the subchannel control volume, and forming a computational mesh; establishing a conservative mapping relationship between physical parameters of the outer-layer mesh and the computational mesh; and establishing a set of transport equations based on the conservative mapping relationship;
S2: decomposing a coolant viscosity-induced frictional effect into coolant-wall friction and coolant-coolant friction, deriving a corresponding frictional pressure drop correlation, and representing a turbulent mixing-induced exchange of a physical quantity through a source term;
S3: establishing, based on the decomposition of the viscosity-induced frictional effect and the turbulent mixing-induced exchange of the physical quantity, a three-dimensional set of governing equations including mass, momentum, and energy conservation equations to describe a flow and heat transfer phenomenon within coolant channels; and discretizing the three-dimensional set of governing equations based on the set of transport equations, and forming a fully assembled matrix system for solving a coolant flow and heat transfer problem;
S4: setting a boundary condition and an initial condition for a physical field of the reactor core, and setting an initial field, where the initial condition includes an initial value of each physical parameter of the physical field to be solved under a steady-state or transient condition of a reactor system; and
S5: iteratively solving the fully assembled matrix system, and obtaining a thermal-hydraulic parameter.

Furthermore, the method further includes: S6: iteratively updating the obtained thermal-hydraulic parameter, and determining whether an iteration converges, where the determining whether an iteration converges specifically includes: determining whether an equation residual of the fully assembled matrix system meets a convergence requirement during the iteration; if yes, exiting the iteration, obtaining a convergent solution for a current time, and updating a time step; and if not, continuing iterative solving.

Furthermore, the method further includes: S7: determining whether to terminate a solving process:
determining whether a solving time exceeds a preset numerical computation time; if not, repeating the steps S3 to S5 to proceed to a loop at a next time step; and otherwise terminating the solving process, and outputting the obtained thermal-hydraulic parameter.

Furthermore, in the step S1, the dividing a fine subchannel control volume, and forming an outer-layer mesh; dividing the subchannel control volume, and forming a computational mesh specifically includes:
S1.1, obtaining the outer-layer mesh through natural geometric division of a coolant flow channel between core rod bundles, and obtaining the computational mesh through division based on a computational efficiency, a spatial resolution requirement, and a transverse flow characteristic, where the computational mesh is obtained through further fine division based on the outer-layer mesh, ensuring that the obtained computational mesh is more refined than the outer-layer mesh but coarser than a computational fluid dynamics (CFD) mesh.

Furthermore, in the step S1, the establishing a conservative mapping relationship between physical parameters of the outer-layer mesh and the computational mesh; and establishing a set of transport equations based on the conservative mapping relationship includes:
S1.2, establishing, by a volume-weighted method, the conservative mapping relationship between the outer-layer mesh and the computational mesh as follows:

$${ϕ}_{o , j} = {\sum }_{i ∈ j} ( \frac{{V}_{i}}{{V}_{o , j}} ) {ϕ}_{i , c}$$

where, ϕ denotes a physical quantity parameter transferred between the two layers of meshes; V denotes a volume of the control volume, unit: m³, and degenerates into an area for a two-dimensional computational object, unit: m²; subscript o denotes the outer-layer mesh; subscript c denotes the computational mesh; subscript j denotes an index of the outer-layer mesh; and subscript i denotes an index of an inner-layer mesh;
S1.3, computing, based on the conservative mapping relationship between the two layers of meshes and by an existing reactor core coolant flow and heat transfer model, a corresponding physical parameter by solving a corresponding constitutive equation over the outer-layer mesh; and mapping the corresponding physical parameter to the computational mesh, expressing the physical parameter in matrix form and generating the set of transport equations as follows:

$${F}_{c \to o} ( {ϕ}_{1 , c} , {ϕ}_{2 , c} , {ϕ}_{3 , c} , … , {ϕ}_{n , c} ) {\to }^{Direct solving} {Ψ}_{o}$$

where, F denotes the existing reactor core coolant flow and heat transfer model; and Ψ denotes the physical parameter ultimately computed by the model.

Furthermore, in the step S2, the decomposing a coolant viscosity-induced frictional effect into coolant-wall friction and coolant-coolant friction, deriving a corresponding frictional pressure drop correlation, and representing a turbulent mixing-induced exchange of a physical quantity through a source term specifically includes:
S2.1, decomposing the coolant viscosity-induced frictional effect based on regions including a grid region and a rod region and based on flow directions including transverse flow and axial flow; and determining one or more types of frictional pressure drops to be computed, including axial rod region frictional pressure drop, axial grid region frictional pressure drop, transverse rod region frictional pressure drop, and transverse grid region frictional pressure drop;
S2.2, decomposing the frictional pressure drop to be computed into coolant-coolant friction and coolant-wall friction, performing implicit and explicit computations separately, and finally obtaining the corresponding frictional pressure drop correlation; and
S2.3, computing the turbulent mixing-induced exchange of the physical quantity by an experimental correlation or a validated numerical solution of CFD software, and obtaining a final turbulent mixing-based source term correlation.

Furthermore, in the step S3, the discretizing the three-dimensional set of governing equations based on the set of transport equations, and forming a fully assembled matrix system for solving a coolant flow and heat transfer problem specifically includes:
performing triple integration on the mass, momentum, and energy conservation equations over the fine subchannel control volume, applying a midpoint rule, and obtaining a semi-discrete equation;
discretizing, based on a requirement of a computational efficiency and a computational accuracy, a transient term, a convective term, a diffusion term, and a source term in the semi-discrete equation respectively in appropriate discretization formats, and finally forming the fully assembled matrix system in the following form:

$$[ \begin{matrix}{a}_{11} & {a}_{12} & … & {a}_{1 N - 1} & {a}_{1 N} \\ {a}_{21} & {a}_{22} & … & {a}_{2 N - 1} & {a}_{2 N} \\ ⋮ & ⋮ & … & ⋮ & ⋮ \\ {a}_{N 1} & {a}_{N 2} & … & {a}_{NN - 1} & {a}_{NN}\end{matrix} ] [ \begin{matrix}{ϕ}_{1} \\ {ϕ}_{2} \\ ⋮ \\ ⋮ \\ {ϕ}_{N}\end{matrix} ] = [ \begin{matrix}{b}_{1} \\ {b}_{2} \\ ⋮ \\ ⋮ \\ {b}_{N}\end{matrix} ]$$

where, a₁₁, a₁₂, . . . a_{NN} denote elements of a discrete equation coefficient matrix; ϕ₁, ϕ₂, . . . ϕ_{N} denote thermal-hydraulic parameters to be solved; and b₁, b₂, . . . b_{N} denote source terms of discrete equations.

Furthermore, in the step S4, the boundary condition of the physical field includes a flow boundary condition and a thermal boundary condition;
the flow boundary condition is derived by specifying a wall boundary, inlet and outlet flow rates, an inlet velocity, and an outlet pressure; and
the thermal boundary condition is derived by specifying a heat flux or solving a fuel rod heat transfer model.

Furthermore, in the step S5, the iteratively solving the fully assembled matrix system, and obtaining a thermal-hydraulic parameter specifically includes:
S5.1, solving an outer-layer transient physical field by a time-marching method, updating a solution at each time level, and determining whether a preset time ends;
S5.2, solving the outer-layer transient physical field by the time-marching method, and setting a time step; taking, for a first iteration, the initial field as an initial guess to start the iteration; and assigning, for an iteration other than the first iteration, a convergent solution from a previous time to a physical field at a current time as an initial guess, where the physical field includes a velocity field, a pressure field, a temperature field, and a mass flow rate at an interface of the control volume;
S5.3, solving the energy conservation equation, obtaining a coolant temperature, and further obtaining a physical property parameter including a fuel rod surface temperature, the coolant temperature, and a coolant density; and
S5.4, assembling and solving a linearized momentum equation based on the steps S3 and S4 at each time level, assembling a pressure correction equation by Rhie-Chow interpolation, solving the pressure correction equation, and iteratively updating a solving process parameter, where the iteratively updating includes updating solutions of the momentum equation and the pressure correction equation.

The present disclosure further provides a three-dimensional thermal-hydraulic analysis system for a reactor core, for implementing the three-dimensional thermal-hydraulic analysis method for a reactor core, and including:
a mesh division module, configured to: analyze a type of a reactor core; determine a type of a rod bundle channel to be solved and a solution domain; divide a fine subchannel control volume, and form an outer-layer mesh; divide the subchannel control volume, and form a computational mesh; establish a conservative mapping relationship between physical parameters of the outer-layer mesh and the computational mesh; and establish a set of transport equations based on the conservative mapping relationship;
a frictional pressure drop and turbulent mixing analysis module, configured to: decompose a coolant viscosity-induced frictional effect into coolant-wall friction and coolant-coolant friction, derive a corresponding frictional pressure drop correlation, and represent a turbulent mixing-induced exchange of a physical quantity through a source term;
a fully assembled matrix system establishment module, configured to: establish, based on the decomposition of the viscosity-induced frictional effect and the turbulent mixing-induced exchange of the physical quantity, a three-dimensional set of governing equations including mass, momentum, and energy conservation equations to describe a flow and heat transfer phenomenon within coolant channels; and discretize the three-dimensional set of governing equations based on the set of transport equations, and form a fully assembled matrix system for solving a coolant flow and heat transfer problem;
an initial parameter setting module, configured to: set a boundary condition and an initial condition for a physical field of the reactor core, and set an initial field, where the initial condition includes an initial value of each physical parameter of the physical field to be solved under a steady-state or transient condition of a reactor system; and
a thermal-hydraulic solving module, configured to: iteratively solve the fully assembled matrix system, and obtain a thermal-hydraulic parameter.

According to the specific embodiments provided in the present disclosure, the present disclosure has the following technical effects:
1) The present disclosure abandons the axial-flow dominance assumption of the traditional subchannel analysis method. Instead, it employs three-dimensional fluid flow and heat transfer governing equations to describe coolant flow and heat transfer processes, rigorously addressing transverse momentum equations. Compared to the conventional subchannel method, the present disclosure eliminates the need for reducing the three-dimensional problem into a two-dimensional problem and enables the resolution of complex three-dimensional flow fields.
2) The present disclosure decomposes the coolant viscosity-induced frictional effect to reduce numerical simulation complexity for turbulent motions. The traditional CFD method requires Reynolds-averaged Navier-Stokes (RANS), large eddy simulation (LES), or direct numerical simulation (DNS). In contrast, the present disclosure achieves faster convergence and superior stability.
3) The present disclosure performs numerical solving on the refined control volume (computational mesh). Compared to the traditional subchannel analysis methods the present disclosure can simulate more refined flow fields, temperature fields, and transverse flow distributions in coolant channels, better reflecting actual thermal-hydraulic processes in the reactor core coolant channels.

The three-dimensional thermal-hydraulic analysis method for a reactor core provided by the present disclosure solves both the transverse flow distribution and more refined velocity distribution in the coolant channels. The present disclosure significantly improves the prediction accuracy of local thermal-hydraulic parameters, and enables more precise thermal-hydraulic analysis.

### BRIEF DESCRIPTION OF THE DRAWINGS

To describe the technical solutions in embodiments of the present disclosure or in the prior art more clearly, the drawings required in the embodiments are briefly described below. Apparently, the drawings in the following description show merely some embodiments of the present disclosure, and other drawings can still be derived from these drawings by those of ordinary skill in the art without creative efforts.

FIG. 1 is a schematic flowchart of a three-dimensional thermal-hydraulic analysis method for a reactor core according to an embodiment of the present disclosure;

FIG. 2 is a schematic diagram of a mesh system including an outer-layer mesh and a computational mesh for a single coolant channel according to the present disclosure;

FIGS. 3A-3D are schematic diagrams of four division methods for the computational mesh according to an embodiment of the present disclosure;

FIG. 4 displays a dual-layer mesh system for a rod bundle case, presenting a specific fine subchannel case of a pressurized water reactor rod bundle in the present disclosure; and FIG. 4 illustrates an outer boundary setting of an inlet and an outlet, as well as computed transverse flow distributions within coolant channels and between adjacent coolant channels;

FIG. 5 is a comparison diagram of computed transverse velocity results for the fine subchannel case of the pressurized water reactor rod bundle shown in FIG. 4, where an orange curve represents a calibrated computational result of CFD software as a reference value for comparative analysis, while a blue curve represents a computational result obtained by the method of the present disclosure.

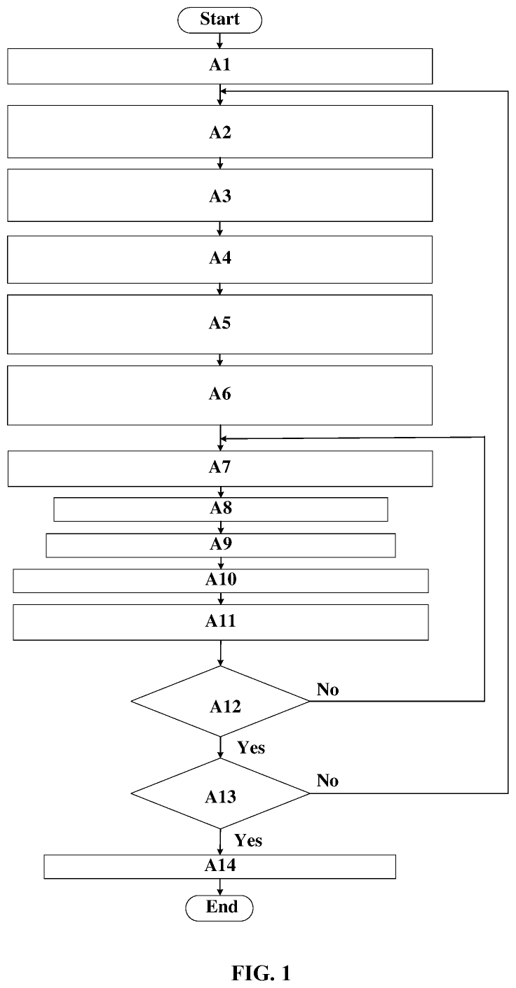

### REFERENCE NUMERALS IN FIG. 1

A1, Analyze a type of a reactor core and a geometrical condition, divide a mesh, determine a mapping relationship, and establish a set of transport equations for achieving data transfer between two layers of meshes and application of an experimental correlation
A2, Determine, based on an analysis object, one or more types of frictional pressure drops to be computed, including axial rod region frictional pressure drop, axial grid region frictional pressure drop, transverse rod region frictional pressure drop, and transverse grid region frictional pressure drop
A3, Decompose the viscosity-induced frictional pressure drop into coolant-wall friction and coolant-coolant friction, perform implicit and explicit computations separately, and finally obtain a corresponding frictional pressure drop correlation
A4, Compute turbulent mixing-induced exchanges of physical quantities including momentum and energy by the experimental correlation or a validated numerical solution of CFD software, and obtain a final turbulent mixing-based source term correlation
A5, List, based on division of a control volume, mass, momentum, and energy conservation equations; discretize; add the frictional pressure drop correlation and the turbulent mixing-based correlation to the corresponding conservation equations; and form a fully assembled matrix system for solving
A6, Set a boundary condition and an initial condition for a physical field, and set a zero initial field; derive a flow boundary condition by specifying inlet and outlet flow rates or an inlet velocity, and an outlet pressure, etc.; and derive a thermal boundary condition by specifying a heat flux or solving a fuel rod model
A7, Solve the energy conservation equation, obtain a coolant temperature, and further obtain a physical property parameter including a fuel rod surface temperature, the coolant temperature, and a coolant density
A8, Solve the momentum conservation equation, and obtain a coolant velocity field
A9, Solve a flow velocity at an interface of the control volume by Rhie-Chow interpolation
A10, Assemble a mass conservation discrete equation based on the flow velocity at the interface, solve the mass conservation discrete equation, and obtain a pressure correction value
A11, Correct a pressure and velocity based on the pressure correction value, and update the flow velocity at the interface of the control volume by Rhie-Chow interpolation based on corrected pressure field and velocity field
A12, Determine whether a current time level meets a convergence criterion
A13, Determine whether a preset numerical computation time is exceeded
A14, Output obtained temperature field, pressure field, and velocity field, and perform corresponding post-processing

### DETAILED DESCRIPTION OF THE INVENTION

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts should fall within the protection scope of the present disclosure.

As described in the background section, the single-channel analysis method and the subchannel analysis method exhibit low-fidelity but offer advantages such as low requirements for computational resources, fast computation, and simple modeling. In contrast, the CFD method is characterized by high requirements for computational resources, slow computation, and complex modeling, but it offers the advantage of high-fidelity. Given the features of the different thermal-hydraulic analysis methods, the present disclosure integrates their strengths while addressing their limitations. Specifically, the present disclosure employs an intermediate-fidelity thermal-hydraulic computational method to enable rapid core computations, achieving medium fidelity and supporting three-dimensional full-core steady-state and transient analysis. The present disclosure provides a three-dimensional thermal-hydraulic analysis method for a reactor core, which is a thermal-hydraulic analysis method for a three-dimensional fine subchannel, aiming to address the technical problems in the prior art.

In order to make the above objective, features and advantages of the present disclosure clearer and more comprehensible, the present disclosure will be further described in detail below in combination with drawings and particular implementation modes.

As shown in FIG. 1, the present disclosure provides a three-dimensional thermal-hydraulic analysis method for a reactor core, including the following steps.
S1: analyzing a type of a reactor core; determining a type of a rod bundle channel to be solved and a solution domain; dividing a fine subchannel control volume, and forming an outer-layer mesh; dividing the subchannel control volume, and forming a computational mesh; establishing a conservative mapping relationship between physical parameters of the outer-layer mesh and the computational mesh; and establishing a set of transport equations based on the conservative mapping relationship;

Specifically, the step S1 involves determining the reactor core type and solution scale. Based on the type of a rod bundle channel to be solved and the solution domain, the fine subchannel control volume is divided to resolve detailed flow and temperature field distributions within coolant channels. To apply the existing flow and heat transfer model to the fine subchannel control volume, additional division of the subchannel control volume is needed to form the outer-layer mesh and the computational mesh. Since the two layers of meshes differ in type, size, and quantity, the conservative mapping relationship for physical parameters between the outer-layer mesh and the computational mesh must be established to ensure mass, momentum, and energy conservation between the two layers of meshes during data exchange. The two mapping relationships between the two layers of meshes are expressed in matrix form to obtain the set of transport equations that guarantees physical parameter transfer conservation between the two layers of meshes.
S2: decomposing a coolant viscosity-induced frictional effect into coolant-wall friction and coolant-coolant friction, deriving a corresponding frictional pressure drop correlation, and representing a turbulent mixing-induced exchange of a physical quantity through a source term;

The step S2 reduces computational complexity and uncertainty caused by simulating intricate turbulent motions.

The step S2 is specifically as follows. When the coolant viscosity-induced frictional effect is decomposed, regional and directional divisions are applied. Regionally, the coolant viscosity-induced frictional effect in the grid region should take more account for an additional frictional pressure drop induced by a mechanical mixing component than the frictional effect in the rod region. Directionally, the transverse and axial frictional pressure drops are computed separately using different frictional pressure drop models. Thus, this step needs to computer the axial rod region frictional pressure drop, axial grid region frictional pressure drop, transverse rod region frictional pressure drop, and transverse grid region frictional pressure drop separately.
S3: establishing, based on the decomposition of the viscosity-induced frictional effect and the turbulent mixing-induced exchange of the physical quantity, a three-dimensional set of governing equations including mass, momentum, and energy conservation equations to describe a flow and heat transfer phenomenon within coolant channels; and discretizing the three-dimensional set of governing equations based on the set of transport equations, and forming a fully assembled matrix system for solving a coolant flow and heat transfer problem;

The three-dimensional set of governing equations describes coolant flow and heat transfer processes within and between channels, incorporating boundary conditions, turbulent mixing, and frictional pressure drops to close the equations for solvability. Combining the set of transport equations and the set of governing equations yields a matrix system, which serves as the final fully assembled matrix system for solving the coolant flow and heat transfer problem.
S4: setting a boundary condition and an initial condition for a physical field of the reactor core, and setting an initial field, where the initial condition includes an initial value of each physical parameter of the physical field to be solved under a steady-state or transient condition of a reactor system; and

An initial field is set to enable iterative solving.
S5. The fully assembled matrix system iteratively solved, and a thermal-hydraulic parameter is obtained.
S6. The obtained thermal-hydraulic parameter is iteratively updated; and it is determined whether an iteration converges. Specifically, it is determined whether an equation residual of the fully assembled matrix system meets a convergence requirement during the iteration. If yes, this step exits the iteration, a convergent solution for a current time is obtained, and the time step is updated. If not, this step continues iterative solving.
S7. It is determined whether to terminate a solving process. It is determined whether a solving time exceeds a preset numerical computation time. If not, the steps S3 to S5 are repeated to proceed to a loop at a next time step. Otherwise, the solving process is terminated, and the obtained thermal-hydraulic parameter is output.

Exemplarily, in the step S1, if the reactor core type is pressurized water reactor, the fine subchannel control volume and the subchannel control volume are divided to form the outer-layer mesh and the computational mesh, respectively, and the conservative mapping relationship between mesh indexes and physical parameters of the outer-layer mesh and the computational mesh is established. Specifically,

To leverage the existing flow and heat transfer model, the two layers of meshes are subjected to a numerical computation. That is, the flow and heat transfer model is applied to the outer-layer mesh and the computational mesh to compute the coolant flow and temperature fields, respectively.

The outer-layer mesh is obtained through natural geometric division of a coolant flow channel between core rod bundles. The computational mesh is obtained through division based on a computational efficiency, a spatial resolution requirement, and a transverse flow characteristic. The computational mesh is obtained through further fine division based on the outer-layer mesh, ensuring that the obtained computational mesh is more refined than the outer-layer mesh but coarser than a computational fluid dynamics (CFD) mesh.

Preferably, in the step S1, the reactor core type and solution scale are analyzed, the mesh is divided, the mapping relationship is determined, and the set of transport equations is established, specifically as follows.
S1.1. The reactor core type and solution scale are analyzed, and the mesh is divided.

This method can be used for numerical simulations of reactor cores of reactors, such as pressurized water reactors, sodium-cooled fast reactors, and lead-bismuth cooled fast reactors, with open coolant channels (lacking box wall assemblies). Take a pressurized water reactor core as an example, to leverage the existing flow and heat transfer model, the two layers of meshes are subjected to a numerical computation. That is, the flow and heat transfer model is applied to the outer-layer mesh and the computational mesh to compute the coolant flow and temperature fields, respectively.

The outer-layer mesh is obtained through natural geometric division of a coolant flow channel between core rod bundles. The computational mesh is obtained through division based on a computational efficiency, a spatial resolution requirement, and a transverse flow characteristic. The computational mesh is obtained through further fine division based on the outer-layer mesh, ensuring that the obtained computational mesh is more refined than the outer-layer mesh but coarser than a CFD mesh. The present disclosure is applicable to any type of mesh with the above-mentioned characteristics.

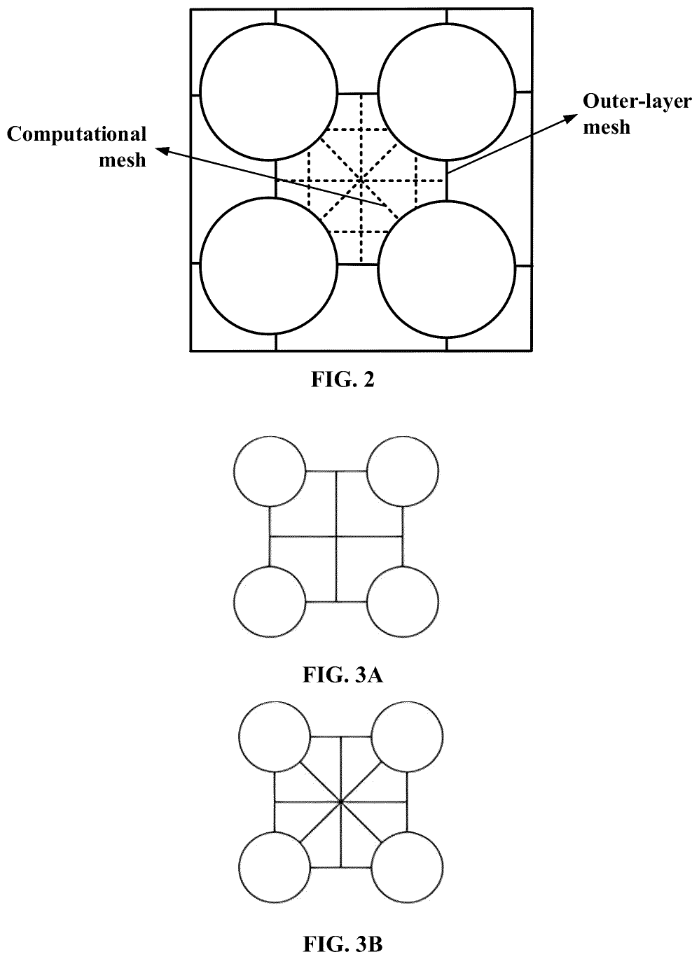

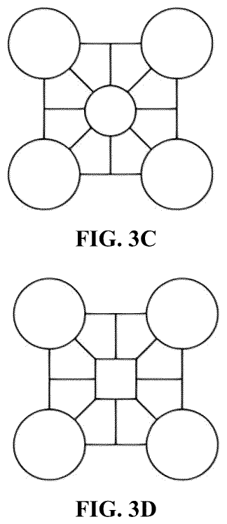

Take a single coolant flow channel surrounded by four fuel rods as an example, the outer-layer mesh is obtained through natural geometric division of the coolant flow channel between rod bundles. As shown in FIG. 2, the outer-layer mesh is the orange-line mesh system. In FIG. 2, the computational mesh is the white-line mesh. While there is only one division method of the outer-layer mesh, the division method of the computational mesh varies. FIGS. 3A-3D shows four division methods of computational meshes.
S1.2. The mapping relationship between the two layers of meshes is established.

Parameters like velocity and temperature are solved over the computational mesh. However, the outer-layer mesh and the computational mesh differ in quantity, type, and size, and one outer-layer mesh corresponds to multiple computational meshes. Therefore, ensure conservation of mass, momentum, and other physical quantities during mesh-mesh data transfer, volume-weighted averaging is applied to establish the mapping relationship between the two layers of meshes as follows:

$${ϕ}_{o , j} = {\sum }_{i ∈ j} ( \frac{{V}_{i}}{{V}_{o , j}} ) {ϕ}_{i , c}$$

where, ϕ denotes a physical quantity parameter transferred between the two layers of meshes; V denotes a volume of the control volume, unit: m³, and degenerates into an area for a two-dimensional computational object, unit: m²; subscript o denotes the outer-layer mesh; subscript c denotes the computational mesh; subscript j denotes an index of the outer-layer mesh; and subscript i denotes an index of an inner-layer mesh.

The temperature parameter transfer between the computational mesh and the outer-layer mesh shown in FIG. 2 is taken as an example to illustrate the above process.

One outer-layer mesh corresponds to 16 computational meshes. The volume (or area)-weighted average temperature for each computational mesh is computed, and the summation of 16 volume (or area)-weighted average temperature yields the computed value of the temperature over the outer-layer mesh.
S1.3. The set of transport equations is established.

Based on the mapping relationship between the two layers of meshes and by an existing reactor core coolant flow and heat transfer model, a corresponding physical parameter is computed by solving a corresponding constitutive equation over the outer-layer mesh. The corresponding physical parameter is mapped to the computational mesh and expressed in matrix form, and the set of transport equations is generated as follows:

$${F}_{c \to o} ( {ϕ}_{1 , c} , {ϕ}_{2 , c} , {ϕ}_{3 , c} , … , {ϕ}_{n , c} ) {\to }^{Direct solving} {Ψ}_{o}$$

where, F denotes the reactor core coolant flow and heat transfer model to be applied; and Ψ denotes the physical parameter ultimately computed by the model. The set of transport equations imposes no restrictions on the form or number of the flow and heat transfer models.

Taking the transverse rod region frictional pressure drop model in a pressurized water reactor core as an example, the set of transport equations for the above model is expressed as follows:

$${F}_{c \to 0} = \frac{{f}_{l}}{Re} + \frac{{f}_{t}}{{Re}^{0.1}} ( 1 - {e}^{\frac{Re + 1000}{2000}} )$$

$$Where ,$$

$$( {ϕ}_{1 , c} , {ϕ}_{2 , c} , {ϕ}_{3 , c} ) = ( {f}_{l} , {f}_{t} , Re )$$

In other words, the laminar friction coefficient fₗ, turbulent friction coefficient fₜ, and Reynolds number Re required by the pressure drop model are mapped from the computational mesh to obtain the laminar friction coefficient, turbulent friction coefficient, and Reynolds number over the outer-layer mesh. These parameters are expressed in matrix form for direct solving, ultimately obtaining the transverse rod region frictional resistance coefficient Ψ.

Preferably, in the step S2, the coolant viscosity-induced frictional effect is decomposed, and the turbulent mixing is represented through a momentum source, specifically as follows.
S2.1. The viscosity-induced frictional effect is analyzed and decomposed.

The viscosity-induced frictional effect is decomposed into coolant-coolant friction and coolant-wall friction. The diffusion term representing the frictional effect is subjected to triple integration over the computational mesh and computed according to a Gauss's formula, as follows:

$${\int \int \int }_{Ω} \overline{σ} \cdot ndV = \overline{σ} \cdot ndA = {\int \int }_{{S}_{f}} \overline{σ} \cdot ddA + {\int \int }_{{S}_{w}} \overline{σ} \cdot ndA$$

where, σ̅ denotes a viscous stress tensor; n denotes a unit normal vector to a surface; Ω denotes a volume of the control volume; S denotes a surface area of the control volume; subscript f denotes a fluid; and subscript w denotes a wall.

The coolant-wall friction is computed as follows:

$${\int \int }_{{S}_{f}} \overline{σ} \cdot ndA = - \frac{1}{8} f {ρ}_{o} {v}_{0} \vert {v}_{o} \vert {\int \int }_{{S}_{w}} dA$$

where, f denotes a frictional resistance coefficient; ρ denotes a coolant density, unit: kg/m³; V denotes a coolant velocity vector, component unit: m/s; and subscript o denotes the outer-layer mesh.

The coolant-coolant friction is computed as follows:

$${\int \int }_{{S}_{f}} \overline{σ} \cdot ndA = {\int \int \int }_{Ω} ∇ \cdot ( μ ∇ v ) dV$$

where, μ denotes a coolant viscosity coefficient, unit: kg/(m·s).

The transverse rod region in a pressurized water reactor core is taken as an example to describe the above process. By performing triple integration on the diffusion term equation over the computational mesh and decomposing and computing the frictional effect, a corresponding semi-discrete equation is obtained as follows:

$$\begin{matrix}\overline{σ} \cdot ndA = {\int \int }_{{S}_{f}} \overline{σ} \cdot ndA + {\int \int }_{{S}_{w}} \overline{σ} \cdot ndA \\ = - \frac{1}{8} f {ρ}_{o} {v}_{o} \vert {v}_{o} \vert {\int \int }_{{S}_{w}} dA + {\int \int \int }_{Ω} ∇ \cdot ( μ ∇ v ) dV \\ = - \frac{1}{8} Ψ {ρ}_{o} {v}_{o} \vert {v}_{o} \vert {\int \int }_{{S}_{w}} dA + {\int \int \int }_{Ω} ∇ \cdot ( μ ∇ v ) dV\end{matrix}$$

S2.2. The source term is computed to characterize the turbulent mixing between coolant channels.

Mechanical mixing components (e.g., mixing vanes) will induce intense turbulent mixing. To quantify the impact of turbulent mixing on the exchange of a physical quantity, the present disclosure employs an appropriate experimental correlation to explicitly compute turbulent mixing and incorporate it into the source term, as follows:

$$∇ \cdot {M}_{M} {\to }^{Triple integration} {\int \int \int }_{Ω} ∇ \cdot {M}_{M} dV = {S}_{M}$$

For example, for a pressurized water reactor core, the turbulent mixing-induced exchange of the physical quantity is expressed as follows:

$$\frac{\partial ρ}{\partial t} + \frac{\partial ( ρ u )}{\partial x} + \frac{\partial ( ρ v )}{\partial y} + \frac{\partial ( ρ w )}{\partial z} = 0$$

where, M_{M} denotes a momentum exchanged due to turbulent mixing, component unit: kg/(m·s); W_{f} denotes a transverse velocity between adjacent control volumes, unit: m/s; φ denotes a physical quantity exchanged due to turbulent mixing; S_{f} denotes an interface area between adjacent control volumes, unit: m²; subscript P denotes a current control volume; and subscript N denotes a neighboring control volume of the current control volume.

Preferably, in the step S3, the set of governing equations is established and discretized to form a fully assembled matrix system, specifically as follows.
S31. The set of governing equations is established as follows. Based on the decomposition of the viscosity-induced frictional effect and the computation of the turbulent mixing, a three-dimensional set of governing equations is established to describe flow and heat transfer phenomena in coolant channels, as follows:

### Mass Conservation Equation:

$$\frac{\partial ρ}{\partial t} + \frac{\partial ( ρ u )}{\partial x} + \frac{\partial ( ρ v )}{\partial y} + \frac{\partial ( ρ w )}{\partial z} = 0$$

### Momentum Conservation Equation:

$$\frac{\partial ( ρ u )}{\partial t} + \frac{\partial ( ρ uu )}{\partial x} + \frac{\partial ( ρ vu )}{\partial y} + \frac{\partial ( ρ wu )}{\partial z} = - \frac{\partial p}{\partial x} + \frac{\partial }{\partial x} ( μ \frac{\partial u}{\partial x} ) + \frac{\partial }{\partial y} ( μ \frac{\partial u}{\partial y} ) + \frac{\partial }{\partial z} ( μ \frac{\partial u}{\partial z} ) + \frac{\partial {M}_{Mx}}{\partial x} + \frac{\partial {M}_{Mx}}{\partial y} + \frac{\partial {M}_{Mx}}{\partial z} + ρ {g}_{x} + {S}_{Mx}$$

$$\frac{\partial ( ρ v )}{\partial t} + \frac{\partial ( ρ uv )}{\partial x} + \frac{\partial ( ρ vv )}{\partial y} + \frac{\partial ( ρ wv )}{\partial z} = - \frac{\partial p}{\partial y} + \frac{\partial }{\partial x} ( μ \frac{\partial v}{\partial x} ) + \frac{\partial }{\partial y} ( μ \frac{\partial v}{\partial y} ) + \frac{\partial }{\partial z} ( μ \frac{\partial v}{\partial z} ) + \frac{\partial {M}_{My}}{\partial x} + \frac{\partial {M}_{My}}{\partial y} + \frac{\partial {M}_{Mz}}{\partial z} + ρ {g}_{y} + {S}_{My}$$

$$\frac{\partial ( ρ w )}{\partial t} + \frac{\partial ( ρ uw )}{\partial x} + \frac{\partial ( ρ vw )}{\partial y} + \frac{\partial ( ρ ww )}{\partial z} = - \frac{\partial p}{\partial z} + \frac{\partial }{\partial x} ( μ \frac{\partial w}{\partial x} ) + \frac{\partial }{\partial y} ( μ \frac{\partial w}{\partial y} ) + \frac{\partial }{\partial z} ( μ \frac{\partial w}{\partial z} ) + \frac{\partial {M}_{Mz}}{\partial x} + \frac{\partial {M}_{Mz}}{\partial y} + \frac{\partial {M}_{Mz}}{\partial z} + ρ {g}_{z} + {S}_{Mz}$$

### Energy Conservation Equation:

$${c}_{p} [ \frac{\partial ( ρ T )}{\partial t} + \frac{\partial ( ρ u T )}{\partial x} + \frac{\partial ( ρ v T )}{\partial y} + \frac{\partial ( ρ w T )}{\partial z} ] = \frac{\partial }{\partial x} ( k \frac{\partial T}{\partial x} ) + \frac{\partial }{\partial y} ( k \frac{\partial T}{\partial y} ) + \frac{\partial }{\partial z} ( k \frac{\partial T}{\partial z} ) - \frac{\partial {M}_{E}}{\partial x} - \frac{\partial {M}_{E}}{\partial y} - \frac{\partial {M}_{E}}{\partial z} + {S}_{E}$$

where, ρ denotes a coolant density, unit: kg/m³; [symbol] w denote coolant velocities in x, y, and z directions, respectively, unit: m/s; p denotes a pressure, unit: Pa; gₓ, g_{y}, g_{z} denote gravitational accelerations in the x, y, and z directions, respectively, unit: m/s²; T denotes a coolant temperature, unit: K; k denotes a thermal conductivity, unit: W/(m·K); M_{Mx}, M_{My}, M_{Mz} denote turbulent mixing-induced momentum fluxes in the x, y, and z directions, respectively, unit: kg/(m·s); M_{E} denotes a turbulent mixing-induced energy flux, unit: J/(m²·s); [symbol] S_{Mz} denote momentum sources formed by frictional and form drag pressure drops from structures such as fuel rod bundles, assembly box walls, and grids in the x, y, and z directions, respectively, unit: kg/(m²·s²); and S_{E} denotes an energy source term, unit: J/(m³·s).
S32. The set of governing equations is discretized, and a fully assembled matrix system is formed. In the duration from t to t+Δt, triple integration is performed on the mass, momentum, and energy conservation equations in the refined control volume, and a midpoint rule is applied, thereby obtaining the following semi-discrete equations:

### Mass Conservation Semi-Discrete Equation:

$${\int }_{t}^{t + Δ t} \frac{\partial ρ}{\partial t} {V}_{C} dt + {\int }_{t}^{t + Δ t} [ {\sum }_{f ∼ nb ( C )} {( ρ v )}_{f} \cdot {S}_{f} ] dt = 0$$

### Momentum Conservation Semi-Discrete Equation:

$${\int }_{t}^{t + Δ t} \frac{\partial ( ρ v )}{\partial t} {V}_{C} dt + {\int }_{t}^{t + Δ t} [ {\sum }_{f ∼ nb ( C )} {( ρ vv )}_{f} \cdot {S}_{f} ] dt - {\int }_{t}^{t + Δ t} [ {\sum }_{f ∼ nb ( C )} {( μ ∇ v )}_{f} \cdot {S}_{f} ] dt = {\int }_{t}^{t + Δ t} [ {\sum }_{f ∼ nb ( C )} {( ∇ {M}_{M}^{v} )}_{f} \cdot {S}_{f} ] dt + {\int }_{t}^{t + Δ t} {S}_{M}^{v} {V}_{C} dt$$

### Energy Conservation Semi-Discrete Equation:

$${\int }_{t}^{t + Δ t} \frac{\partial ( ρ T )}{\partial t} {V}_{C} dt + {\int }_{t}^{t + Δ t} [ {\sum }_{f ∼ nb ( C )} {( ρ vT )}_{f} \cdot {S}_{f} ] dt - {\int }_{t}^{t + Δ t} [ {\sum }_{f ∼ nb ( C )} {( k ∇ T )}_{f} \cdot {S}_{f} ] dt = {\int }_{t}^{t + Δ t} [ {\sum }_{f ∼ nb ( C )} {( ∇ {M}_{E} )}_{f} \cdot {S}_{f} ] dt + {\int }_{t}^{t + Δ t} {S}_{E} {V}_{C} dt$$

where, V_{C} denotes a volume of the control volume, unit: m³; subscript f denotes a computed value at an interface of the control volume; superscript v denotes the three directions in the momentum equation, namely x, y, and z; and subscript f [symbol] nb(C) denotes a surface enclosing the current control volume C.

Based on a requirement of a computational efficiency and a computational accuracy, a transient term, a convective term, a diffusion term, and a source term in the semi-discrete equation are discretized respectively in appropriate discretization formats, and finally the fully assembled matrix system in the following form is generated:

$$[ \begin{matrix}{a}_{11} & {a}_{12} & … & {a}_{1 N - 1} & {a}_{1 N} \\ {a}_{21} & {a}_{22} & … & {a}_{2 N - 1} & {a}_{2 N} \\ ⋮ & ⋮ & … & ⋮ & ⋮ \\ {a}_{N 1} & {a}_{N 2} & … & {a}_{NN - 1} & {a}_{NN}\end{matrix} ] [ \begin{matrix}{ϕ}_{1} \\ {ϕ}_{2} \\ ⋮ \\ ⋮ \\ {ϕ}_{N}\end{matrix} ] = [ \begin{matrix}{b}_{1} \\ {b}_{2} \\ ⋮ \\ ⋮ \\ {b}_{N}\end{matrix} ]$$

where, a₁₁, a₁₂, . . . a_{NN} denote elements of a discrete equation coefficient matrix; ϕ₁, ϕ₂, . . . ϕ_{N} denote physical quantities to be solved, such as velocity, pressure, and temperature; and b₁, b₂, . . . b_{N} denote source terms of discrete equations.

Preferably, in the step S4, the boundary condition, the initial condition, and the initial field of the physical field are set.

The present disclosure defines the boundary condition and the initial condition based on the research object and the coolant flow and heat transfer problem. The flow boundary condition typically includes wall boundary, specified mass flow rate outlet boundary, and specified velocity inlet boundary. A thermal boundary condition is obtained by specifying a heat flux or solving the fuel rod heat transfer model. To solve a transient physical field, it is additionally necessary to set an initial condition. To iteratively solve the fully assembled matrix system, an initial field needs to be specified. Since the initial field does not affect the final solution, the temperature, pressure, and velocity fields can be initialized to zero.

Preferably, in the step S5, the matrix system is solved, specifically as follows:
S5.1. An outer-layer transient physical field is solved by a time-marching method, a solution at each time level is updated, and it is determined whether a preset time ends.
S5.2. The outer-layer transient physical field is solved by the time-marching method, and a time step is set. For a first iteration, the initial field is taken as an initial guess to start the iteration. For an iteration other than the first iteration, a convergent solution from a previous time is assigned to a physical field at a current time as an initial guess. The physical field includes a velocity field, a pressure field, a temperature field, and a mass flow rate at an interface of the control volume.
S5.3. The energy conservation equation is solved, a coolant temperature is obtained, and further a physical property parameter including a fuel rod surface temperature, the coolant temperature, and a coolant density is obtained.
S5.4. A linearized momentum equation is assembled and solved based on the steps S3 and S4 at each time level to obtain a velocity field v*, and the mass flow rate at the interface is computed by Rhie-Chow interpolation, as follows:

$${v}_{f} = \overline{{v}_{f}} - \overline{{D}_{f}^{v}} ( ∇ {p}_{f} - \overline{∇ {p}_{f}} ) \overline{{D}_{f}^{v}} = [ \begin{matrix}\overline{{D}_{f}^{u}} & 0 & 0 \\ 0 & \overline{{D}_{f}^{v}} & 0 \\ 0 & 0 & \overline{{D}_{f}^{w}}\end{matrix} ]$$

$$\begin{matrix}{m}_{f} = A ρ {v}_{f} \cdot {S}_{f} \\ {D}_{f}^{u} = \frac{{V}_{f}}{{a}_{f}^{u}} \\ {D}_{f}^{v} = \frac{{V}_{f}}{{a}_{f}^{v}} \\ {D}_{f}^{w} = \frac{{V}_{f}}{{a}_{f}^{w}}\end{matrix}$$

where, v denotes a coolant velocity, unit: m/s; p denotes a coolant pressure, unit: Pa; ρ denotes a coolant density, unit: kg/m³; m denotes a mass flow rate, unit: kg/s; S_{f} denotes a unit normal vector to a surface; A denotes a surface area, unit: m²; a denotes a pivot element of a discretized momentum equation; V denotes a volume of the control volume, unit: m³; subscript f denotes an interface between adjacent control volumes; and superscripts u, v, w denote the x, y, and z directions, respectively.

A pressure correction equation is assembled based on the obtained mass flow rate and is solved to obtain a pressure correction value p′. The pressure is corrected based on the pressure correction value, the velocity is corrected, and the mass flow rate at the interface is re-computed by Rhie-Chow interpolation.

Preferably, in the step S6, it is determined whether to converge, and the related physical property parameter is updated, as follows.

The solution and process parameter are iteratively updated, and it is determined whether the iteration converges. The physical property parameter is updated based on the obtained temperature field. It is determined whether the iteration converges as follows. It is determined whether an equation residual meets a convergence requirement during a loop. If yes, this step exits the loop, and a convergent solution for a current time is obtained. The time step is updated, t=t+Δt. If not, this step continues the loop.
S7. It is determined whether to terminate a numerical solving process.

It is determined whether a set termination time is exceeded. If not, this step proceeds to a loop at a next time step. Otherwise, the numerical solving process is terminated, and the obtained physical field such as velocity field, pressure field, and temperature field is output.

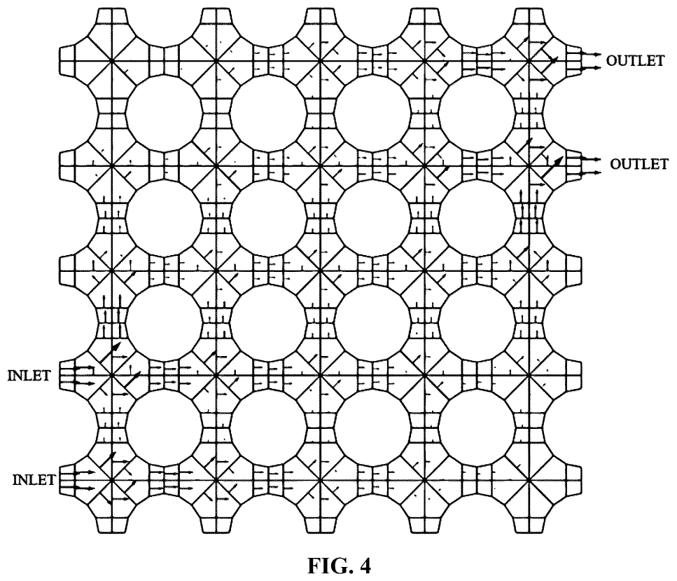

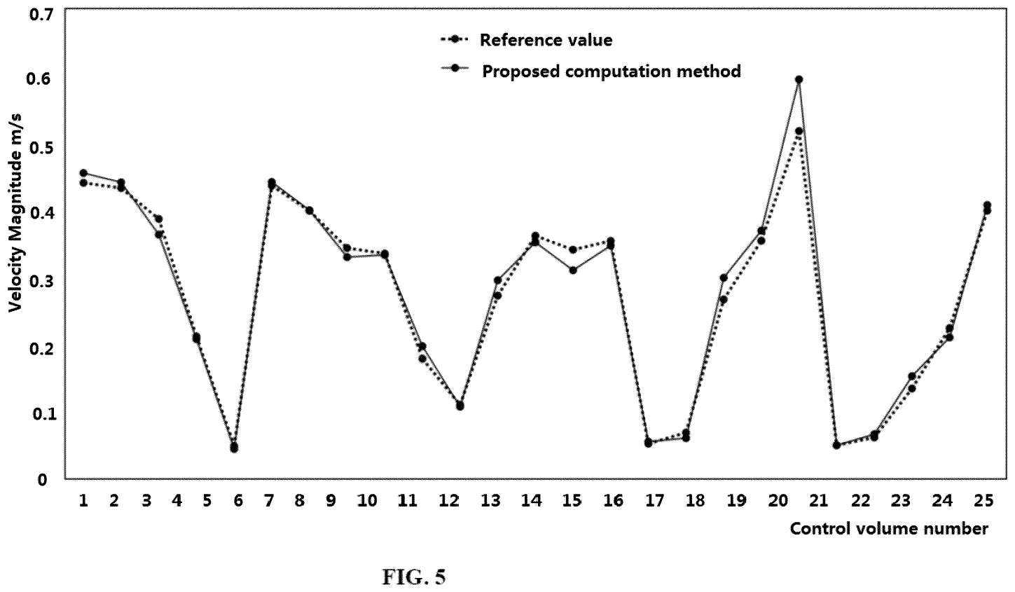

FIGS. 4 and 5 show that the method of the present disclosure can be used for thermal-hydraulic analysis to solve both the transverse flow distribution and more refined velocity distribution in the coolant channels. The present disclosure significantly improves the prediction accuracy of local thermal-hydraulic parameters, and enables more precise thermal-hydraulic analysis.

The present disclosure further provides a three-dimensional thermal-hydraulic analysis system for a reactor core, for implementing the three-dimensional thermal-hydraulic analysis method for a reactor core, and including: a mesh division module, a frictional pressure drop and turbulent mixing analysis module, a fully assembled matrix system establishment module, an initial parameter setting module, and a thermal-hydraulic solving module.

The mesh division module is configured to: analyze a type of a reactor core; determine a type of a rod bundle channel to be solved and a solution domain; divide a fine subchannel control volume, and form an outer-layer mesh; divide the subchannel control volume, and form a computational mesh; establish a conservative mapping relationship between physical parameters of the outer-layer mesh and the computational mesh; and establish a set of transport equations based on the conservative mapping relationship;

The frictional pressure drop and turbulent mixing analysis module is configured to: decompose a coolant viscosity-induced frictional effect into coolant-wall friction and coolant-coolant friction, derive a corresponding frictional pressure drop correlation, and represent a turbulent mixing-induced exchange of a physical quantity through a source term;

The fully assembled matrix system establishment module is configured to: establish, based on the decomposition of the viscosity-induced frictional effect and the turbulent mixing-induced exchange of the physical quantity, a three-dimensional set of governing equations including mass, momentum, and energy conservation equations to describe a flow and heat transfer phenomenon within coolant channels; and discretize the three-dimensional set of governing equations based on the set of transport equations, and form a fully assembled matrix system for solving a coolant flow and heat transfer problem;

The initial parameter setting module is configured to: set a boundary condition and an initial condition for a physical field of the reactor core, and set an initial field, where the initial condition includes an initial value of each physical parameter of the physical field to be solved under a steady-state or transient condition of a reactor system; and

The thermal-hydraulic solving module is configured to: iteratively solve the fully assembled matrix system, and obtain a thermal-hydraulic parameter.

Those skilled in the art should understand that the drawings are only schematic diagrams of an embodiment, and the modules or processes in the drawings are not necessary for implementing the present disclosure.

Specific examples are used herein to explain the principles and implementations of the present disclosure. The foregoing description of the embodiments is merely intended to help understand the method of the present disclosure and its core ideas; besides, various modifications may be made by those of ordinary skill in the art to specific implementations and the scope of application in accordance with the ideas of the present disclosure. In conclusion, the content of the description shall not be construed as limitations to the present disclosure.

What is claimed is:

1. A three-dimensional thermal-hydraulic analysis method for a reactor core, comprising the following steps:
S1: analyzing a type of a reactor core; determining a type of a rod bundle channel to be solved and a solution domain; dividing a fine subchannel control volume, and forming an outer-layer mesh; dividing the subchannel control volume, and forming a computational mesh; establishing a conservative mapping relationship between physical parameters of the outer-layer mesh and the computational mesh; and establishing a set of transport equations based on the conservative mapping relationship;
S2: decomposing a coolant viscosity-induced frictional effect into coolant-wall friction and coolant-coolant friction, deriving a corresponding frictional pressure drop correlation, and representing a turbulent mixing-induced exchange of a physical quantity through a source term;
S3: establishing, based on the decomposition of the viscosity-induced frictional effect and the turbulent mixing-induced exchange of the physical quantity, a three-dimensional set of governing equations comprising mass, momentum, and energy conservation equations to describe a flow and heat transfer phenomenon within coolant channels; and discretizing the three-dimensional set of governing equations based on the set of transport equations, and forming a fully assembled matrix system for solving a coolant flow and heat transfer problem;
S4: setting a boundary condition and an initial condition for a physical field of the reactor core, and setting an initial field, wherein the initial condition comprises an initial value of each physical parameter of the physical field to be solved under a steady-state or transient condition of a reactor system; and
S5: iteratively solving the fully assembled matrix system, and obtaining a thermal-hydraulic parameter.

2. The three-dimensional thermal-hydraulic analysis method for a reactor core according to claim 1, wherein the method further comprises: S6: iteratively updating the obtained thermal-hydraulic parameter, and determining whether an iteration converges, wherein the determining whether an iteration converges specifically comprises: determining whether an equation residual of the fully assembled matrix system meets a convergence requirement during the iteration; if yes, exiting the iteration, obtaining a convergent solution for a current time, and updating a time step; and if not, continuing iterative solving.

3. The three-dimensional thermal-hydraulic analysis method for a reactor core according to claim 1, wherein the method further comprises: S7: determining whether to terminate a solving process:
determining whether a solving time exceeds a preset numerical computation time; if not, repeating the steps S3 to S5 to proceed to a loop at a next time step; and otherwise terminating the solving process, and outputting the obtained thermal-hydraulic parameter.

4. The three-dimensional thermal-hydraulic analysis method for a reactor core according to claim 1, wherein in the step S1, the dividing a fine subchannel control volume, and forming an outer-layer mesh; dividing the subchannel control volume, and forming a computational mesh specifically comprises:
S1.1, obtaining the outer-layer mesh through natural geometric division of a coolant flow channel between core rod bundles, and obtaining the computational mesh through division based on a computational efficiency, a spatial resolution requirement, and a transverse flow characteristic, wherein the computational mesh is obtained through further fine division based on the outer-layer mesh, ensuring that the obtained computational mesh is more refined than the outer-layer mesh but coarser than a computational fluid dynamics (CFD) mesh.

5. The three-dimensional thermal-hydraulic analysis method for a reactor core according to claim 1, wherein in the step S1, the establishing a conservative mapping relationship between physical parameters of the outer-layer mesh and the computational mesh; and establishing a set of transport equations based on the conservative mapping relationship comprises:
S1.2, establishing, by a volume-weighted method, the conservative mapping relationship between the outer-layer mesh and the computational mesh as follows:
$${ϕ}_{o , j} = {\sum }_{i ∈ j} ( \frac{{V}_{i}}{{V}_{o , j}} ) {ϕ}_{i , c}$$
wherein, ϕ denotes a physical quantity parameter transferred between the two layers of meshes; V denotes a volume of the control volume, unit: m³, and degenerates into an area for a two-dimensional computational object, unit: m²; subscript o denotes the outer-layer mesh; subscript c denotes the computational mesh; subscript j denotes an index of the outer-layer mesh; and subscript i denotes an index of an inner-layer mesh;
S1.3, computing, based on the conservative mapping relationship between the two layers of meshes and by an existing reactor core coolant flow and heat transfer model, a corresponding physical parameter by solving a corresponding constitutive equation over the outer-layer mesh; and mapping the corresponding physical parameter to the computational mesh, expressing the physical parameter in matrix form, and generating the set of transport equations as follows:
$${F}_{c \to o} ( {ϕ}_{1 , c} , {ϕ}_{2 , c} , {ϕ}_{3 , c} , … , {ϕ}_{n , c} ) {\to }^{Direct solving} {Ψ}_{o}$$
wherein, F denotes the existing reactor core coolant flow and heat transfer model; and Ψ denotes the physical parameter ultimately computed by the model.

6. The three-dimensional thermal-hydraulic analysis method for a reactor core according to claim 1, wherein in the step S2, the decomposing a coolant viscosity-induced frictional effect into coolant-wall friction and coolant-coolant friction, deriving a corresponding frictional pressure drop correlation, and representing a turbulent mixing-induced exchange of a physical quantity through a source term specifically comprises:
S2.1, decomposing the coolant viscosity-induced frictional effect based on regions comprising a grid region and a rod region and based on flow directions comprising transverse flow and axial flow; and determining one or more types of frictional pressure drops to be computed, comprising axial rod region frictional pressure drop, axial grid region frictional pressure drop, transverse rod region frictional pressure drop, and transverse grid region frictional pressure drop;
S2.2, decomposing the frictional pressure drop to be computed into coolant-coolant friction and coolant-wall friction, performing implicit and explicit computations separately, and finally obtaining the corresponding frictional pressure drop correlation; and
S2.3, computing the turbulent mixing-induced exchange of the physical quantity by an experimental correlation or a validated numerical solution of CFD software, and obtaining a final turbulent mixing-based source term correlation.

7. The three-dimensional thermal-hydraulic analysis method for a reactor core according to claim 1, wherein in the step S3, the discretizing the three-dimensional set of governing equations based on the set of transport equations, and forming a fully assembled matrix system for solving a coolant flow and heat transfer problem specifically comprises:
performing triple integration on the mass, momentum, and energy conservation equations over the fine subchannel control volume, applying a midpoint rule, and obtaining a semi-discrete equation;
discretizing, based on a requirement of a computational efficiency and a computational accuracy, a transient term, a convective term, a diffusion term, and a source term in the semi-discrete equation respectively in appropriate discretization formats, and finally forming the fully assembled matrix system in the following form:
$$[ \begin{matrix}{a}_{11} & {a}_{12} & … & {a}_{1 N - 1} & {a}_{1 N} \\ {a}_{21} & {a}_{22} & … & {a}_{2 N - 1} & {a}_{2 N} \\ ⋮ & ⋮ & … & ⋮ & ⋮ \\ {a}_{N 1} & {a}_{N 2} & … & {a}_{NN - 1} & {a}_{NN}\end{matrix} ] [ \begin{matrix}{ϕ}_{1} \\ {ϕ}_{2} \\ ⋮ \\ ⋮ \\ {ϕ}_{N}\end{matrix} ] = [ \begin{matrix}{b}_{1} \\ {b}_{2} \\ ⋮ \\ ⋮ \\ {b}_{N}\end{matrix} ]$$
wherein, a₁₁, a₁₂, . . . a_{NN} denote elements of a discrete equation coefficient matrix; ϕ₁, ϕ₂, . . . ϕ_{N} denote thermal-hydraulic parameters to be solved; and b₁, b₂, . . . b_{N} denote source terms of discrete equations.

8. The three-dimensional thermal-hydraulic analysis method for a reactor core according to claim 1, wherein in the step S4, the boundary condition of the physical field comprises a flow boundary condition and a thermal boundary condition;
the flow boundary condition is derived by specifying a wall boundary, inlet and outlet flow rates, an inlet velocity, and an outlet pressure; and
the thermal boundary condition is derived by specifying a heat flux or solving a fuel rod heat transfer model.

9. The three-dimensional thermal-hydraulic analysis method for a reactor core according to claim 1, wherein in the step S5, the iteratively solving the fully assembled matrix system, and obtaining a thermal-hydraulic parameter specifically comprises:
S5.1, solving an outer-layer transient physical field by a time-marching method, updating a solution at each time level, and determining whether a preset time ends;
S5.2, solving the outer-layer transient physical field by the time-marching method, and setting a time step; taking, for a first iteration, the initial field as an initial guess to start the iteration; and assigning, for an iteration other than the first iteration, a convergent solution from a previous time to a physical field at a current time as an initial guess, wherein the physical field comprises a velocity field, a pressure field, a temperature field, and a mass flow rate at an interface of the control volume;
S5.3, solving the energy conservation equation, obtaining a coolant temperature, and further obtaining a physical property parameter comprising a fuel rod surface temperature, the coolant temperature, and a coolant density; and
S5.4, assembling and solving a linearized momentum equation based on the steps S3 and S4 at each time level, assembling a pressure correction equation by Rhie-Chow interpolation, solving the pressure correction equation, and iteratively updating a solving process parameter, wherein the iteratively updating comprises updating solutions of the momentum equation and the pressure correction equation.

10. A three-dimensional thermal-hydraulic analysis system for a reactor core, for implementing the three-dimensional thermal-hydraulic analysis method for a reactor core according to claim 1, and comprising:
a mesh division module, configured to: analyze a type of a reactor core; determine a type of a rod bundle channel to be solved and a solution domain; divide a fine subchannel control volume, and form an outer-layer mesh; divide the subchannel control volume, and form a computational mesh; establish a conservative mapping relationship between physical parameters of the outer-layer mesh and the computational mesh; and establish a set of transport equations based on the conservative mapping relationship;
a frictional pressure drop and turbulent mixing analysis module, configured to: decompose a coolant viscosity-induced frictional effect into coolant-wall friction and coolant-coolant friction, derive a corresponding frictional pressure drop correlation, and represent a turbulent mixing-induced exchange of a physical quantity through a source term;
a fully assembled matrix system establishment module, configured to: establish, based on the decomposition of the viscosity-induced frictional effect and the turbulent mixing-induced exchange of the physical quantity, a three-dimensional set of governing equations comprising mass, momentum, and energy conservation equations to describe a flow and heat transfer phenomenon within coolant channels; and discretize the three-dimensional set of governing equations based on the set of transport equations, and form a fully assembled matrix system for solving a coolant flow and heat transfer problem;
an initial parameter setting module, configured to: set a boundary condition and an initial condition for a physical field of the reactor core, and set an initial field, wherein the initial condition comprises an initial value of each physical parameter of the physical field to be solved under a steady-state or transient condition of a reactor system; and
a thermal-hydraulic solving module, configured to: iteratively solve the fully assembled matrix system, and obtain a thermal-hydraulic parameter.

11. The three-dimensional thermal-hydraulic analysis system for a reactor core according to claim 10, wherein the method further comprises: S6: iteratively updating the obtained thermal-hydraulic parameter, and determining whether an iteration converges, wherein the determining whether an iteration converges specifically comprises: determining whether an equation residual of the fully assembled matrix system meets a convergence requirement during the iteration; if yes, exiting the iteration, obtaining a convergent solution for a current time, and updating a time step; and if not, continuing iterative solving.

12. The three-dimensional thermal-hydraulic analysis system for a reactor core according to claim 10, wherein the method further comprises: S7: determining whether to terminate a solving process:
determining whether a solving time exceeds a preset numerical computation time; if not, repeating the steps S3 to S5 to proceed to a loop at a next time step; and otherwise terminating the solving process, and outputting the obtained thermal-hydraulic parameter.

13. The three-dimensional thermal-hydraulic analysis system for a reactor core according to claim 10, wherein in the step S1, the dividing a fine subchannel control volume, and forming an outer-layer mesh; dividing the subchannel control volume, and forming a computational mesh specifically comprises:
S1.1, obtaining the outer-layer mesh through natural geometric division of a coolant flow channel between core rod bundles, and obtaining the computational mesh through division based on a computational efficiency, a spatial resolution requirement, and a transverse flow characteristic, wherein the computational mesh is obtained through further fine division based on the outer-layer mesh, ensuring that the obtained computational mesh is more refined than the outer-layer mesh but coarser than a computational fluid dynamics (CFD) mesh.

14. The three-dimensional thermal-hydraulic analysis system for a reactor core according to claim 10, wherein in the step S1, the establishing a conservative mapping relationship between physical parameters of the outer-layer mesh and the computational mesh; and establishing a set of transport equations based on the conservative mapping relationship comprises:
S1.2, establishing, by a volume-weighted method, the conservative mapping relationship between the outer-layer mesh and the computational mesh as follows:
$${ϕ}_{o , j} = {\sum }_{i ∈ j} ( \frac{{V}_{i}}{{V}_{o , j}} ) {ϕ}_{i , c}$$
wherein, ϕ denotes a physical quantity parameter transferred between the two layers of meshes; V denotes a volume of the control volume, unit: m³, and degenerates into an area for a two-dimensional computational object, unit: m²; subscript o denotes the outer-layer mesh; subscript c denotes the computational mesh; subscript j denotes an index of the outer-layer mesh; and subscript i denotes an index of an inner-layer mesh;
S1.3, computing, based on the conservative mapping relationship between the two layers of meshes and by an existing reactor core coolant flow and heat transfer model, a corresponding physical parameter by solving a corresponding constitutive equation over the outer-layer mesh; and mapping the corresponding physical parameter to the computational mesh, expressing the physical parameter in matrix form, and generating the set of transport equations as follows:
$${F}_{c \to o} ( {ϕ}_{1 , c} , {ϕ}_{2 , c} , {ϕ}_{3 , c} , … , {ϕ}_{n , c} ) {\to }^{Direct solving} {Ψ}_{o}$$
wherein, F denotes the existing reactor core coolant flow and heat transfer model; and Ψ denotes the physical parameter ultimately computed by the model.

15. The three-dimensional thermal-hydraulic analysis system for a reactor core according to claim 10, wherein in the step S2, the decomposing a coolant viscosity-induced frictional effect into coolant-wall friction and coolant-coolant friction, deriving a corresponding frictional pressure drop correlation, and representing a turbulent mixing-induced exchange of a physical quantity through a source term specifically comprises:
S2.1, decomposing the coolant viscosity-induced frictional effect based on regions comprising a grid region and a rod region and based on flow directions comprising transverse flow and axial flow; and determining one or more types of frictional pressure drops to be computed, comprising axial rod region frictional pressure drop, axial grid region frictional pressure drop, transverse rod region frictional pressure drop, and transverse grid region frictional pressure drop;
S2.2, decomposing the frictional pressure drop to be computed into coolant-coolant friction and coolant-wall friction, performing implicit and explicit computations separately, and finally obtaining the corresponding frictional pressure drop correlation; and
S2.3, computing the turbulent mixing-induced exchange of the physical quantity by an experimental correlation or a validated numerical solution of CFD software, and obtaining a final turbulent mixing-based source term correlation.

16. The three-dimensional thermal-hydraulic analysis system for a reactor core according to claim 10, wherein in the step S3, the discretizing the three-dimensional set of governing equations based on the set of transport equations, and forming a fully assembled matrix system for solving a coolant flow and heat transfer problem specifically comprises:
performing triple integration on the mass, momentum, and energy conservation equations over the fine subchannel control volume, applying a midpoint rule, and obtaining a semi-discrete equation;
discretizing, based on a requirement of a computational efficiency and a computational accuracy, a transient term, a convective term, a diffusion term, and a source term in the semi-discrete equation respectively in appropriate discretization formats, and finally forming the fully assembled matrix system in the following form:
$$[ \begin{matrix}{a}_{11} & {a}_{12} & … & {a}_{1 N - 1} & {a}_{1 N} \\ {a}_{21} & {a}_{22} & … & {a}_{2 N - 1} & {a}_{2 N} \\ ⋮ & ⋮ & … & ⋮ & ⋮ \\ {a}_{N 1} & {a}_{N 2} & … & {a}_{NN - 1} & {a}_{NN}\end{matrix} ] [ \begin{matrix}{ϕ}_{1} \\ {ϕ}_{2} \\ ⋮ \\ ⋮ \\ {ϕ}_{N}\end{matrix} ] = [ \begin{matrix}{b}_{1} \\ {b}_{2} \\ ⋮ \\ ⋮ \\ {b}_{N}\end{matrix} ]$$
wherein, a₁₁, a₁₂, . . . a_{NN} denote elements of a discrete equation coefficient matrix; ϕ₁, ϕ₂, . . . ϕ_{N} denote thermal-hydraulic parameters to be solved; and b₁, b₂, . . . b_{N} denote source terms of discrete equations.

17. The three-dimensional thermal-hydraulic analysis system for a reactor core according to claim 10, wherein in the step S4, the boundary condition of the physical field comprises a flow boundary condition and a thermal boundary condition;
the flow boundary condition is derived by specifying a wall boundary, inlet and outlet flow rates, an inlet velocity, and an outlet pressure; and
the thermal boundary condition is derived by specifying a heat flux or solving a fuel rod heat transfer model.

18. The three-dimensional thermal-hydraulic analysis system for a reactor core according to claim 10, wherein in the step S5, the iteratively solving the fully assembled matrix system, and obtaining a thermal-hydraulic parameter specifically comprises:
S5.1, solving an outer-layer transient physical field by a time-marching method, updating a solution at each time level, and determining whether a preset time ends;
S5.2, solving the outer-layer transient physical field by the time-marching method, and setting a time step; taking, for a first iteration, the initial field as an initial guess to start the iteration; and assigning, for an iteration other than the first iteration, a convergent solution from a previous time to a physical field at a current time as an initial guess, wherein the physical field comprises a velocity field, a pressure field, a temperature field, and a mass flow rate at an interface of the control volume;
S5.3, solving the energy conservation equation, obtaining a coolant temperature, and further obtaining a physical property parameter comprising a fuel rod surface temperature, the coolant temperature, and a coolant density; and
S5.4, assembling and solving a linearized momentum equation based on the steps S3 and S4 at each time level, assembling a pressure correction equation by Rhie-Chow interpolation, solving the pressure correction equation, and iteratively updating a solving process parameter, wherein the iteratively updating comprises updating solutions of the momentum equation and the pressure correction equation.
